(19) United States
(12) Patent Application Publication
(10) Pub. No.: US 2005/0176421 A1
(43) Pub. Date: Aug. 11, 2005

(54) Multiple subscription service for wireless communications

(76) Inventors: Narendra Matenge, Mumbai (IN); Amitava Datta, Mumbai (IN)

Correspondence Address: STEPTOE & JOHNSON LLP, 1330 CONNECTICUT AVENUE, N.W., WASHINGTON, DC, 20036, US

(21) Appl. No.: 11/037,255

(22) Filed: Jan. 19, 2005

Related U.S. Application Data
(60) Provisional application No. 60/537,022, filed on Jan. 20, 2004.

(51) Int. Cl. H04Q 7/20

(52) U.S. Cl. 455/426.1; 455/552.1; 455/461

(57) ABSTRACT

Multiple Subscription Service (MSS) expands the functional operational area of a wireless phone that is initially limited for use within one Short Distance Calling Area (SDCA) under one subscription agreement. MSS supports multiple wireless subscriptions for a single handset, thereby allowing the handset to function in multiple SDCAs. In addition, MSS allows for the automatic self-subscription of the handset in an unsubscribed area. MSS therefore enables roaming like service for wireless phones that are initially limited for use within a particular subscription area.

### FIELD OF THE INVENTION

The present invention relates to the field of wireless communications, and in particular to a system for expanding the mobility of wireless telephones.

### BACKGROUND OF THE INVENTION

In a fixed telephone system, the local loop is the physical connection between the subscriber's premise and a carrier's point of presence. The local loop is sometimes called the “last mile” (though not literally limited to a distance of one mile). For example, the local loop may be provided by twisted pair cable between a central office and subscriber's residence.

A fixed wireless local loop provides the “last mile” of connectivity using some form of wireless communications. They generally consist of a pair of transceivers placed on rooftops—one at a central office and the other at the customer's premises.

In contrast, a cellular mobile telephone system uses multiple transceiver sites to provide connectivity to mobile handsets. Cellular mobile telephone systems seek to provide service over a geographically wide service area spanning multiple transceiver sites, and roaming over multiple networks.

### SUMMARY OF THE INVENTION

The present invention is a novel Mobile Subscription Service (MSS) for wireless local loop telephones. Last mile service is wireless, but not necessarily fixed. For example, last mile service may be provided using CDMA technology. Wireless local loop handset connectivity is limited by subscription to a single (local) service area, referred to here as a Short Distance Calling Area (SDCA). For example, a wireless local loop handset may be limited to operating only within a single cell.

By use of MSS, it is possible to expand the operational area of a wireless local loop handset to multiple SDCAs. For example, a wireless local loop handset may be associated with a first directory number while in its home service area. When operating in a different service area, the wireless local loop phone may be associated with a second, different directory number.

In addition, MSS allows for the automatic self-subscription of the wireless phone in an unsubscribed area. In each SDCA, the wireless local loop handset may be associated with a distinct directory number. MSS therefore enables roaming-like service for wireless phones whose subscription otherwise limits them to a single subscription area.

### BRIEF DESCRIPTION OF THE DRAWINGS

The present invention is further described in the detailed description which follows, in reference to the noted drawings by way of non-limiting examples of certain embodiments of the present invention, in which like numerals represent like elements throughout the several views of the drawings, and wherein:

FIG. 1 illustrates a Signaling System 7 communications architecture supporting a Multiple Subscription Service;

FIG. 2 illustrates an origination and termination of a telephone call in a Signaling System 7 network;

FIG. 3 illustrates portions of a wireless local loop system using an SS7 architecture;

FIG. 4 illustrates a wireless network supporting a Multiple Subscription Service and a registration of a wireless phone in a home Short Distance Charging Area;

FIG. 5 depicts a flowchart that illustrates registration of a wireless phone with an MSS system in a home Short Distance Charging Area;

FIG. 6 illustrates a wireless network supporting a Multiple Subscription Service and a registration of a wireless phone in a subscribed Short Distance Charging Area;

FIG. 7 depicts a flowchart that illustrates registration of a wireless phone with an MSS system in a subscribed Short Distance Charging Area;

FIG. 8 illustrates a wireless network supporting a Multiple Subscription Service and a registration of a wireless phone in an unsubscribed Short Distance Charging Area;

FIG. 9 depicts a flowchart that illustrates registration of a wireless phone with an MSS system in an unsubscribed Short Distance Charging Area;

FIG. 10 illustrates an origination of a wireless communication from a wireless phone operating with Multiple Subscription Service;

FIG. 11 depicts a flowchart that illustrates an origination of a wireless communication from a wireless phone operating with Multiple Subscription Service;

FIG. 12 illustrates an exemplary termination of a wireless communication to a wireless phone registered with a home Short Distance Charging Area;

FIG. 13 depicts a flowchart that illustrates an exemplary termination of a wireless communication to a wireless phone registered with a home Short Distance Charging Area;

FIG. 14 illustrates an exemplary termination of a wireless communication to a wireless phone registered within a subscribed Short Distance Charging Area;

FIG. 15 depicts a flowchart that illustrates an exemplary termination of a wireless communication to a wireless phone registered with in a subscribed Short Distance Charging Area;

FIG. 16 illustrates an exemplary termination of a wireless communication to a wireless phone registered where the wireless phone is operating in an area that is different than the one covered by the dialed Mobile Designation Number;

FIG. 17 depicts a flowchart that illustrates an exemplary termination of a wireless communication to a wireless phone registered where the wireless phone is operating in an area that is different than the one covered by the dialed Mobile Designation Number;

FIG. 18 illustrates a transmission of a mobile originated text message to a phone operating with a Multiple Subscription Service; and

FIG. 19 depicts a flowchart that illustrates a transmission of a mobile originated text message to a phone operating with a Multiple Subscription Service.

### DETAILED DESCRIPTION OF PREFERRED EMBODIMENTS

Signaling System 7 (SS7) is a well-known system architecture used for voice and data communications in a public switch telephone network. SS7 also supports wireless call service including mobile telephone subscriber authentication, personal communication service (PCS), and roaming. One characteristic of SS7 is out-of-band signaling. That is, control signaling to set up and manage calls takes place over separate communication network rather than within the same network that the telephone call is made on. Signaling information is in the form of digital messages. An SS7 message may contain information that a particular network point is experiencing heavy loading. Other messages may include instructions to use a particular route only for calls of a certain priority. Another SS7 message may identify a wireless device as a valid wireless subscriber and include an instruction to continue with setting up the call. In addition, SS7 is used for billing, managing call forwarding, calling party name and number display, three-way calling, and other Intelligent Network (IN) services. SS7 is now an international telecommunications standard.

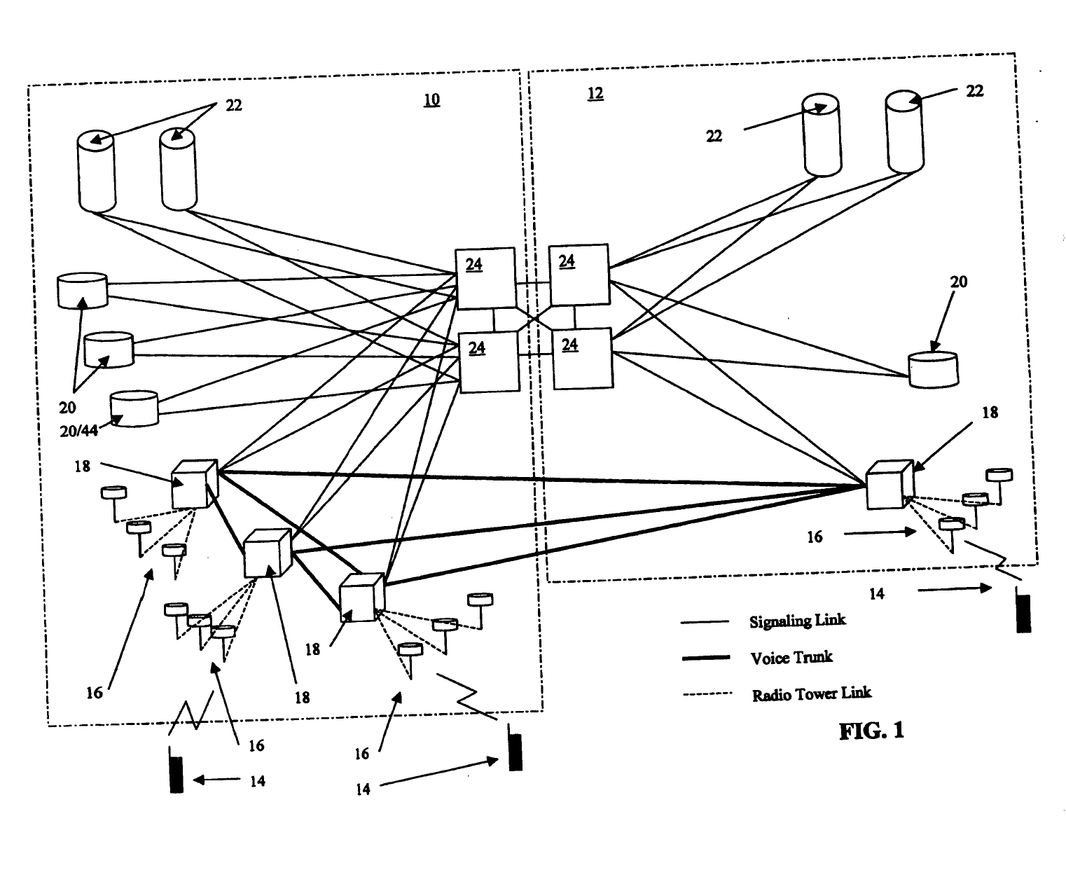

FIG. 1 illustrates an SS7 communications system. In particular, FIG. 1 illustrates two interconnected networks 10, 12, in addition to a number of Mobile Subscribers (MSs) 14. In general, networks 10,12 route calls from MSs to other MSs or to other telephone networks. Networks 10 and 12 include radio towers 16, Mobile Switching Centers (MSCs) 18, Signal Transfer Points (STPs) 24, Signal Control Points (SCPs) 22, and Home Location Registers (HLRs) 20. Network components and operation will be discussed in more detail below.

Mobile Subscribers (MSs) 14 are radio devices capable of sending and receiving voice calls and/or text messages. MSs 14 may include any wireless device, such as a wireless mobile handset. MSs communicate with radio towers 16 over radio channels which are shown in FIG. 1 as zig-zag lines. FIG. 1 illustrates two exemplary MSs associated with network 10, and a single MS associated with network 12; however, it should be understood that the number of MSs and their distribution may vary up to a large number, as high as tens of thousands or more. Each Radio tower relays signaling and voice/text data from MSs in its coverage area to associated MSCs over radio tower links, which are shown as dashed lines. Radio tower links carry both signaling and voice/data traffic. FIG. 1 illustrates three radio towers 16 associated with each MSC, however, it should be understood that the number of radio towers may vary. Typically, each MS is associated with a single directory number, i.e., a number that can be dialed to establish a call with that particular MS.

Mobile Switching Centers (MSCs) 18 are switches that route calls to/from MSs (via associated radio towers), other MSCs, and other Telephone Networks. FIG. 1 illustrates voice trunks between MSCs as heavy weight solid lines. FIG. 1 illustrates network 10 as having three MSCs, and network 12 as having a single MSC. FIG. 1 also illustrates each MSC as having a trunk connection to every other MSC; however, it should be understood that the numbers of MSCs and their interconnectivity may vary. MSCs also communicate with and control wireless radio towers 16 to set-up and terminate calls with MSs 14.

Signal Transfer Points (STPs) 24 are packet switches that route signaling messages. Call signaling takes place over separate communication channels from the voice/text data. FIG. 1 illustrates signaling channels as lighter weight solid lines. FIG. 1 illustrates two STPs in each network 10, 12, with each STP 24 interconnected with each other STP; however, it should be understood that the number of STPs and their interconnectivity may vary. STPs 24 are preferably implemented with redundant interconnectivity, even as redundant pairs, so that service can continue if any single STP 24 should fail. Redundant STPs preferably are not co-located.

Signal Control Points (SCP's) 22 are databases that store service-provider instructions and data that directs switch processing and provide call control. In FIG. 1, each network has two SCPs, with each SCP connected to two STPs 24; however, it should be understood that the number of SCPs and their interconnectivity may vary. The SCPs 22 also execute user-defined programs that analyze the state of a call. Redundant SCPs 22 preferably are not co-located.

Home Location Registers (HLRs) 20 are databases maintained by MSCs 18. HLRs 20 contain databases of user (subscriber) information, including billing or residence address, subscription account status, and subscriber preferences. HLRs 20 also maintain temporary user information, such as current locations of subscriber's MSs. FIG. 1 illustrates three HLRs in network 10 and a single HLR in network 12, with each HLR connected to two STPs 20; however, it will be understood that the number of HLRs and their interconnectivity may vary.

In the preferred implementation, components of networks 10 and 12 comply with CDMA wireless network standards as defined in the Third Generation Partnership Project 2 (3GPP2). Signaling between the various components within wireless networks 10 and 12 occurs according to IS-41d standards. However, it will become apparent that benefits of the invention can be realized in other networks.

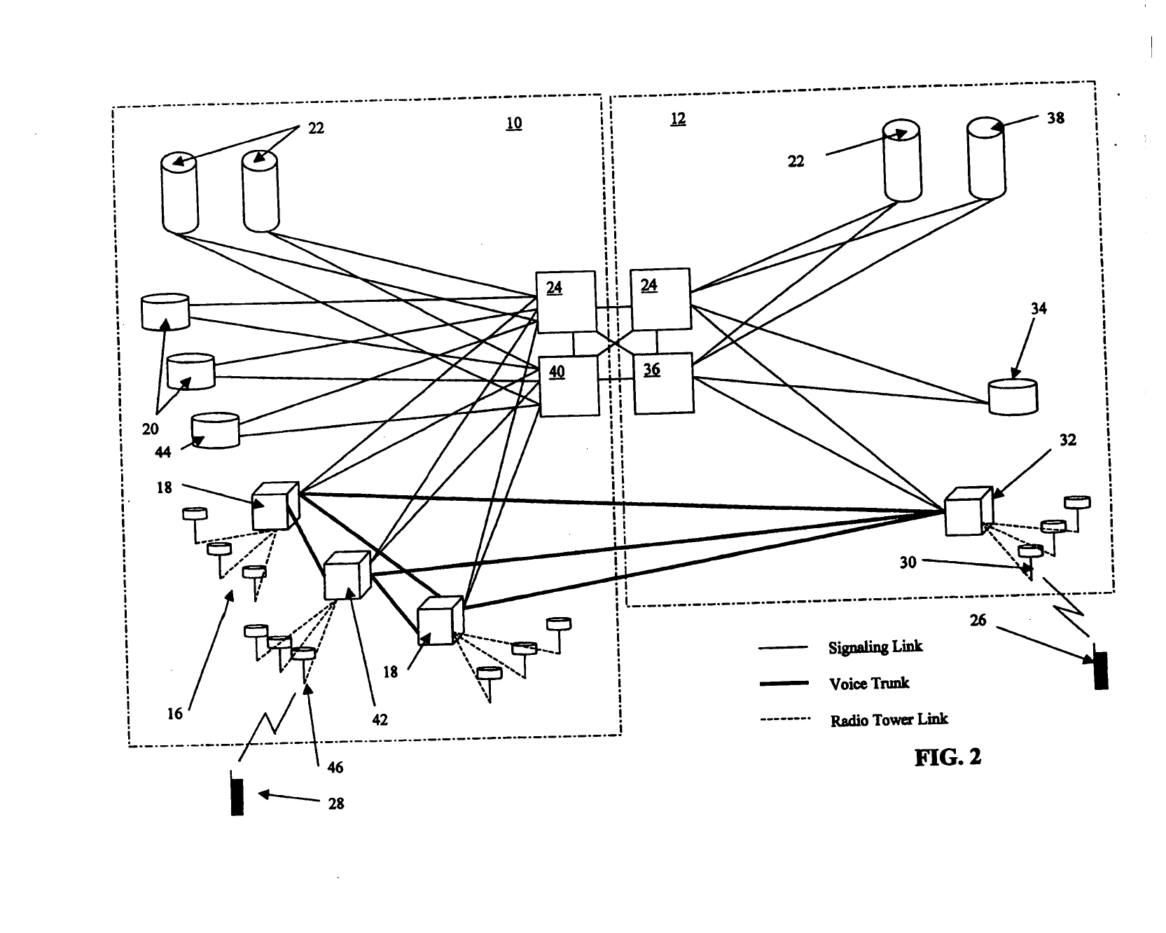

Before discussing detailed aspects of the improved system and method of the present invention, it will be helpful to describe a common method of making a call through an SS7 system with reference to FIG. 2. FIG. 2 describes the same architecture of as FIG. 1; however, some elements have been given specific reference numerals for ease of identification. An origination and termination of a telephone call in networks 10 and 12 will be described here for an MS 26 in network 12 initiating a telephone call to an MS 28 located in network 10.

Before initiating or receiving any calls, MSs 12, 28 first register with the respective networks in which they are located using a well known registration process. Each MS has a “home” network and an associated HLR. For this example, the home network of MS 26 is network 12, and its associated HLR is HLR 34. The home network of MS 28 is network 10, and its associated HLR is HLR 44. In the registration process, each MS communicates through a radio tower, and the respective home networks store information about the location of their MSs. In this example, HLR 44 stores location information about MS 28, and HLR 34 stores location information about MS 26. Home location registers associate information about a subscriber's director number with its location. In this example, HLR 44 stores information that directory number for MS 28 is active through a tower of MSC 42.

To initiate a specific call to MS 28, the originating MS 26 of network 12 transmits a message containing the directory number of the destination MS 14 of network 10. A radio tower 30 of network 12 receives the message and relays it to MSC 32, which is associated with the receiving tower 30 of network 12. The receiving MSC 32 of network 12 in turn queries an SCP 38 associated with the receiving MSC 32. In this example, the SCP 38 is not part of the home network of the destination MS 28, and therefore the SCP 38 cannot immediately reply with routing information. Instead, the SCP 38 queries the home network 10 of the destination MS 28 based on the directory number of the destination MS 28. HLR 44 of the home network 10 of the destination MS 28 provides the location of the destination MS 28. In this example, the destination MS 28 can be reached through MSC 42. SCP 38 provides routing information to MSC 32. MSC 32 then can route the call to MSC 42, which in turn sets up the call with MS 28 through wireless tower 46.

In some cellular telephone applications, SS7 permits a mobile subscriber to initiate and received calls from any location served by the subscriber's home or any other interconnected network. In the case of a wireless local loop system discussed further below, a subscriber's coverage region is limited to the coverage area of a single tower or towers associated with a single MSC 18.

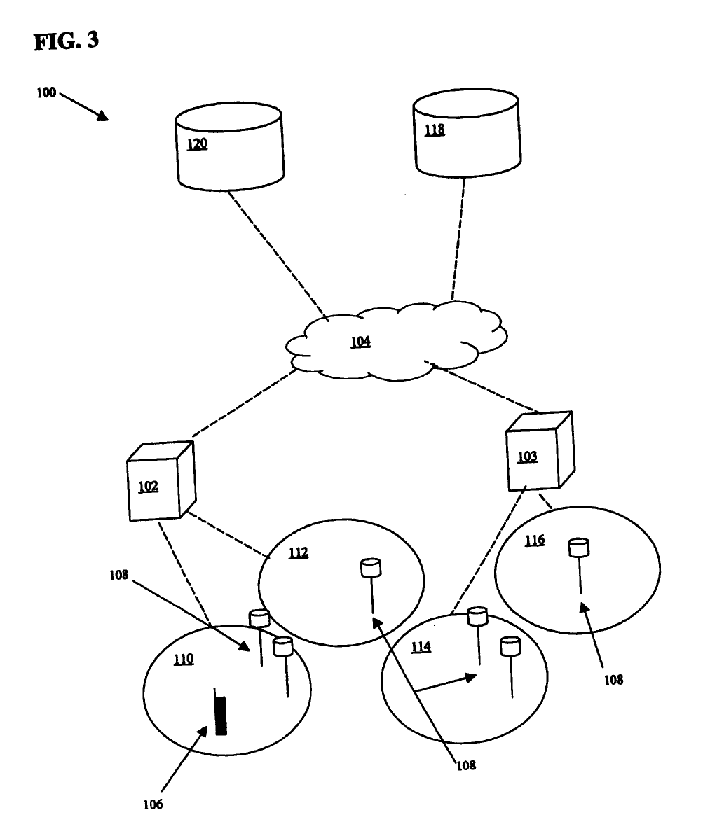

FIG. 3 illustrates portions of a Wireless Local Loop (WLL) system 100 using an SS7 architecture. Network coverage is subdivided into a plurality of Short Distance Calling Areas (SDCAS) 110, 112, 114, 116. Each SDCA may be limited to the coverage area of a single radio tower 108, or multiple radio towers 108, but their coverage area is less than the total area supported by the network. FIG. 3 illustrates four SDCAs 110, 112, 114, 116; however, it will be understood that a network may include any number of SDCAs greater than one. FIG. 3 illustrates SDCAs 110, 112, 114, 116 as having one or two towers 108; however, it will be understood that SDCAs 110, 112, 114, 116 may have any number of towers 108 or other transceiver structures, so long as an SDCA covers less than the total area served by the network. Preferably, SDCAs are one of the several areas into which a Long Distance Charging Area is divided and declared as such for the purpose of charging for long distance calls and within which the local call charges and local numbering scheme is applicable. An SDCA may represent a local calling area, such that calls placed within a single SDCA are billed as local calls. Calls that cross more than one SDCA are a long distance call and billed accordingly. In this example, MSs may only operate within their home SDCAs under a single subscription agreement.

MSs operate with the network under subscription agreements. Such subscription agreements provide MS 106 with a Mobile Directory Number (MDN), which is a number that can be dialed to call the telephone or other mobile device associated with the subscription agreement. One form of subscription agreement for use in a wireless local loop system allows a MS to be mobile anywhere within a single, “home” SDCA and to operate there with a single MDN. However, this form of subscription agreement does not permit an MS to operate outside of the home SDCA under its given MDN. Consequently, in spite of having a wireless capability, mobile subscribers of such a wireless local loop system are limited to operating within their respective home SDCA.

FIG. 3 illustrates an SS7 network 104 as a cloud. It should be understood that network 104 may include MSCs, STPs, HLRs, and SCPs of the type described in connection with FIG. 1 as networks 10, 12. However, the network is modified to limit MSs to operate under subscriptions within a single SDCA as described above.

In FIG. 3, wireless local loop (WLL) network 100 includes MSCs 102 and 103 that support Home Location Registers (HLRs) 118 and 120. The illustration of two MSCs 102 and 103 is merely exemplary. Any number of MSCs may function as a part of WLL 100. Similarly, the display of two HLRs 118 and 120 is merely exemplary as any number of HLRs may function with WLL 100. MSCs 102 and 103 communicate with HLRs 118 and 120 over signaling links through network 104. In this example, MSC 102 is the serving MSC for SDCAs 110 and 112. MSC 103 is the serving MSC for SDCAs 114 and 116.

Multiple Subscription Service (MSS) expands the functional operational area of Mobile Subscribers that otherwise would be limited to use within one Short Distance Calling Area under one subscription agreement. MSS supports multiple subscriptions for a single Mobile Subscriber that allows a wireless local loop mobile device to operate outside its home SDCA. MSS enables mobile subscribers to operate in multiple SDCAs by providing mobile subscribers with distinct MDNs for each SDCA. In addition, MSS allows for the automatic self-subscription of MS 106 in an unsubscribed SDCA. MSS therefore enables roaming like service for wireless phones that are initially limited for use within one SDCA.

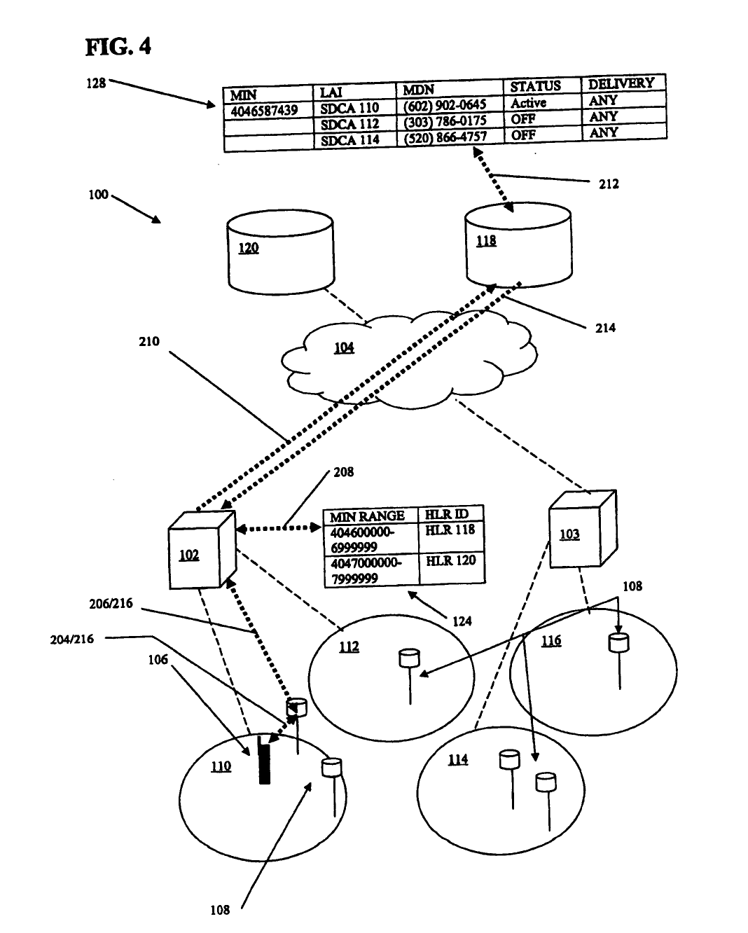

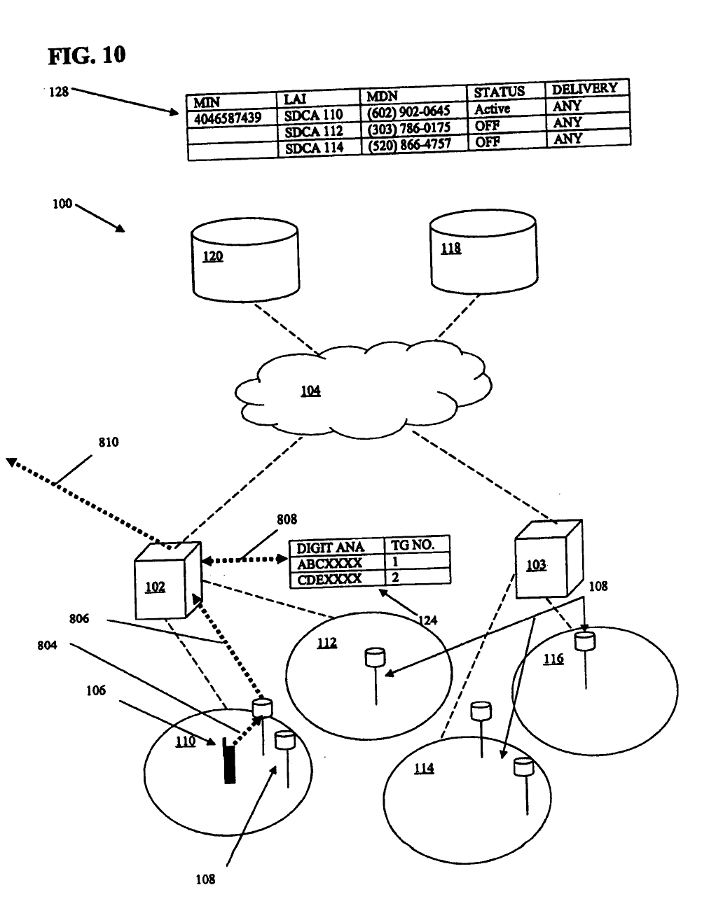

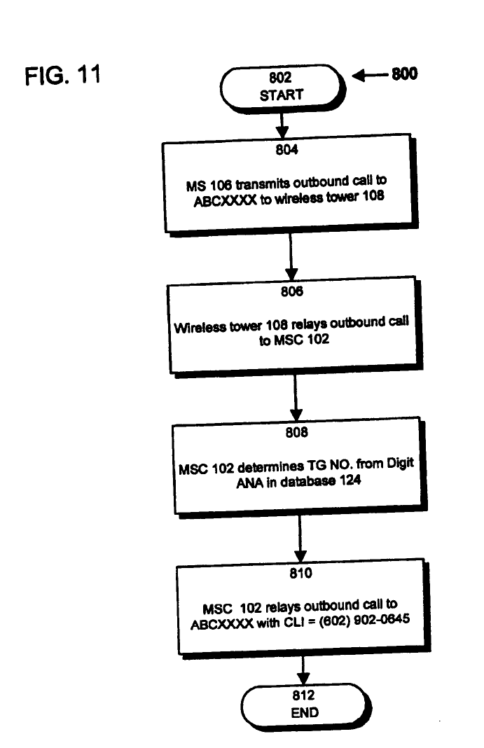

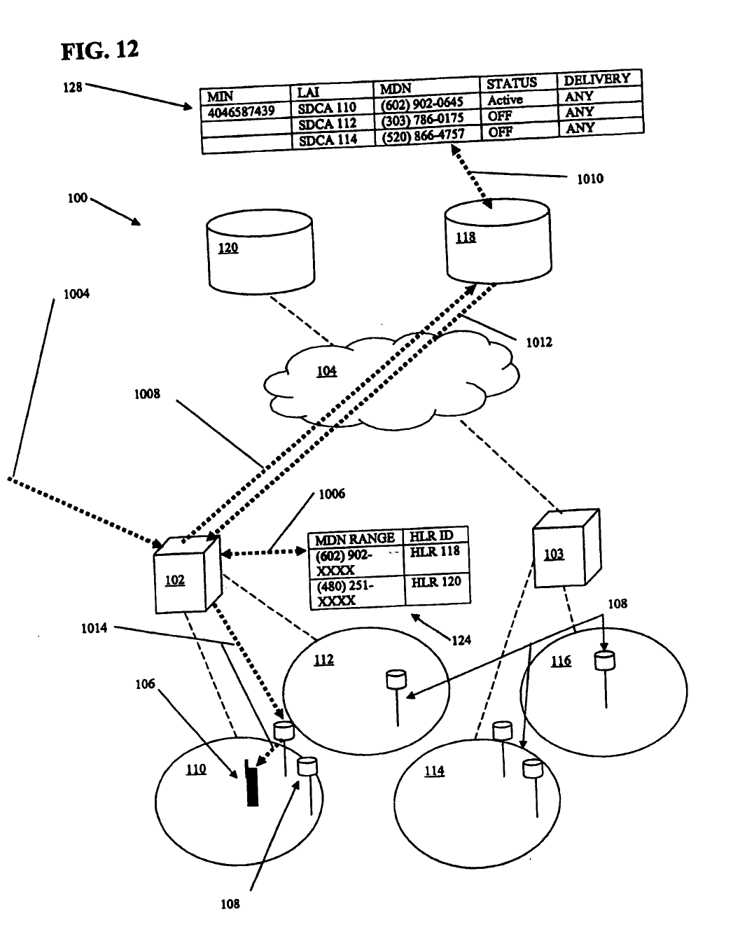

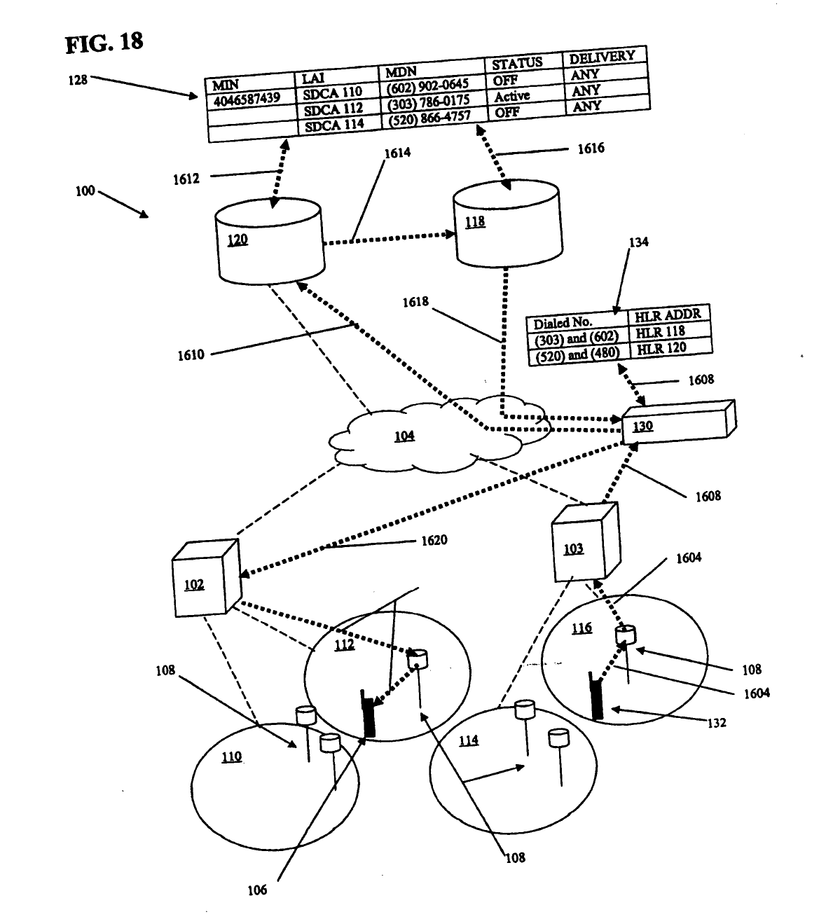

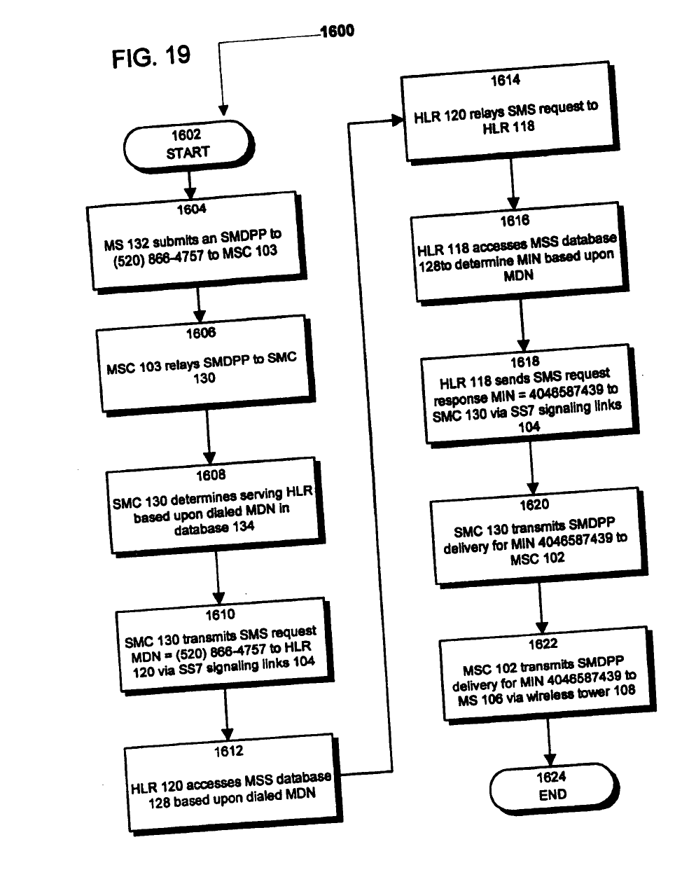

The basic interactions between mobile subscribers and their network are registration, call origination, and call termination. The registration of mobile subscribers operating with MSS is illustrated in FIGS. 4-9. A call origination from a mobile subscriber operating with MSS is illustrated in FIGS. 10 and 11. Call terminations to mobile subscribers operating with MSS are illustrated in FIGS. 12-17. In addition to supporting voice communications, MS 106 can also support text messaging with MSS. The origination and termination of a text message with MS 106 operating with MSS is illustrated in FIGS. 18 and 19.

FIG. 4 illustrates a wireless network supporting a Multiple Subscription Service and a registration of a wireless phone in a home Short Distance Charging Area. Wireless network 100 includes a Mobile Switching Center (MSC) 102 and 103, a Signaling System 7 (SS7) Network 104 represented by a cloud, and a Mobile Subscriber (MS) 106. MS 106 is a wireless phone that communicates with MSC 102 through a wireless receiver tower 108. MS 106 is located in a Short Distance Calling Area (SDCA) 110, represented by an oval. SDCA 110 can support a plurality of receiver towers 108. An exemplary two towers 108 are illustrated in FIG. 4. MS 106 and wireless network 100 communicate through a Code Division Multiple Access (CDMA) technique.

MS 106 is provided with a Mobile Identity Number (MIN) that uniquely identifies MS 106 within wireless network 100. MS 106 operates under a subscription that limits its mobility to one SDCA 110. A Mobile Directory Number (MDN) is assigned to MS 106 for its operation within the one SDCA. It is not possible for MS 106 to operate outside of SDCA 110 with its assigned MDN under this one subscription agreement. It is highly desirable to expand the geographic range of MS 106 beyond SDCA 110 as limited by its subscription into other SDCAs 112, 114, and 116.

It is possible to expand the geographic range of MS 106 beyond SDCA 110 into additional SDCAs by providing MS 106 with a Multiple Subscription Service (MSS). MSS provides a system and method that enables MS 106 to operate in multiple SDCAs under multiple subscription agreements. With MSS, MS 106 acquires a new subscription for each SDCA. MS 106 operates in one SDCA under one subscription agreement. With multiple subscription agreements, MS 106 is able to operate in multiple SDCAs. As a result, MS 106 is provided with a roaming ability.

With MSS, MS 106 acquires a different MDN for each different subscription agreement and corresponding SDCA. Consequently, when operating under multiple subscription agreements, MS 106 will possess multiple MDNs. However, in spite of having these multiple MDNs, MS 106 continues to only have one MIN that uniquely identifies it within wireless network 100. This unique MIN belongs to HLR 118 that corresponds with home SDCA 110. An MSS Database enables MS 106 to operate seamlessly under these multiple subscriptions with multiple MDNs.

The MSS Database stores a listing of all MDNs associated with the MIN that uniquely identifies MS 106. When MS 106 is activated and registers with wireless network 100, the MSS Database records the active MDN that MS 106 is operating under at that time as well as serving MSC 102. The active MDN is the MDN an MSS subscriber has acquired and registered under due to the presence of MS 106 in a particular SDCA. By mapping the information contained in MSS Database 128, wireless network 100 is able to direct telephone calls to and from MS 106.

In FIG. 4, MS 106 has three subscription agreements: one for SDCA 110, one for SDCA 112, and one for SDCA 114. MS 106 is provided with a separate MDN for each SDCA 110, 112, and 114. Each of these MDNs is affiliated with the unique MIN that identifies MS 106 in network 100. These MDNs are affiliated with the unique MIN in the MSS database supported by HLR 118. Consequently, with three subscriptions, MS 106 can roam amongst three SDCAs. MSS therefore provides a method and system for wireless network 100 whereby MS 106 can function simultaneously under multiple subscription agreements. While each subscription agreement only provides functionality to MS 106 for a single SDCA, multiple subscription agreements enable MS 106 to function in multiple SDCAs. As MS 106 moves amongst SDCAs 110, 112, and 114, MS 106 switches between the various subscription agreements for each respective SDCA.

MS 106 will attempt to register itself with wireless network 100 when it is turned on. The registration process varies depending upon whether MS 106 is attempting to register within its home SDCA 110, a subscribed visiting SDCA 112, or an unsubscribed SDCA. In this example, MS 106 is subscribed to three SDCAs under its MSS agreement as illustrated in table 128 representing an exemplary record in the MSS Database. These SDCAs are its home SDCA 110 and two additional SDCAs 112 and 114. MS 106 is provided with an MIN that corresponds to HLR 118 of its home SDCA 110. Wireless network 100 is able to identify that LR 118 is the HLR for MS 106 based upon the MIN. Each HLR is provided with a unique and unduplicated range of MINs.

MSS Database contains a record 128 of the MIN for MS 106. This record includes all of the subscriptions that are affiliated with MS 106 and the corresponding Location Area Identifications (LAI), MDNs, and status. For instance, in this example, MS 106 has a MIN of 4046587439. This MIN is supported by HLR 118, which services wireless devices having MIN numbers within the range of 4046000000 to 4046999999. Consequently, within wireless network 100, HLR 118 is designated as the “home” HLR for MS 106. In MSS Database 128, MS 106 has an MDN on (602) 902-0645 for SDCA 110, an MDN of (303) 786-0175 for SDCA 112, and an MDN of (303) 442-6677 for SDCA 114. All three of these MDNs are linked to MS 106 via the MIN.

Once MS 106 is turned on in its home SDCA 110, it sends a registration request message 204, illustrated as a dotted line, to wireless tower 108. Wireless tower relays this message to the serving MSC 102 in communication 206. This registration request includes the MIN of MS 106. MSC 102 makes a query 208 of its database 124 to determine the home HLR of MS 106 based upon the MIN received from MS 106, which in this case is HLR 118. MSC 102 sends a registration request message 210 to HLR 118 along with an LAI identifying SDCA 110. HLR 118 receives the MIN and LAI information and makes a query 212 of MSS Database 128 to determine the corresponding MDN that MS 106 will operate under in SDCA 110. HLR 118 then registers MS 106 as active with the MDN corresponding to SDCA 110, which is (602) 902-0645, based upon the received message containing the MIN and LAI information. This MDN is passed back to MSC 102 in a response message 214 to the registration request from MS 106. HLR 118 then updates its MSS Database to note the identity of MSC 102 that is serving MS 106 against the MIN of MS 106 and the status. The MSS Database includes a pointer that identifies the active MDN of MS 106, shown in table 128 as status. MSC 102 then relays the registration response to MS 106 via wireless tower 108 in communication 216.

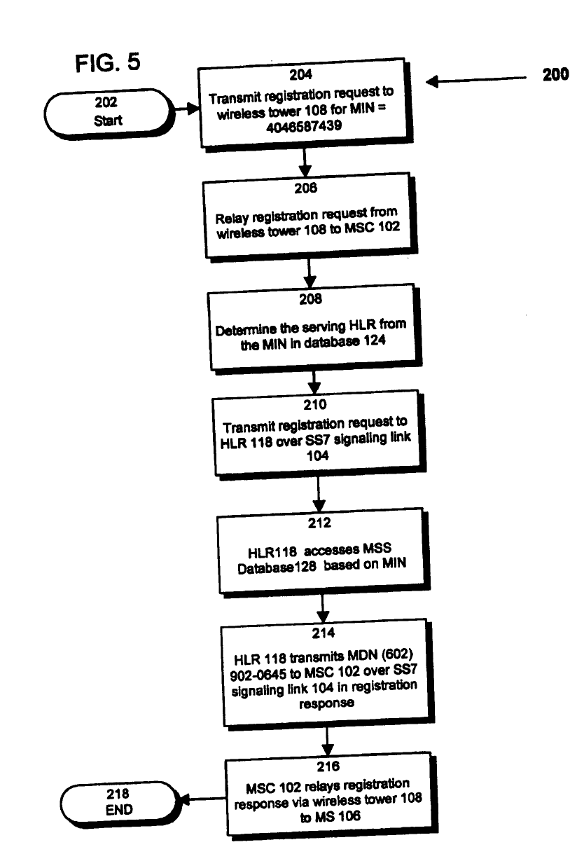

FIG. 5 depicts a flowchart 200 that illustrates registration of MS 106 with an MSS system in home Short Distance Charging Area 110. FIG. 5 illustrates the process occurring in FIG. 4. Registration begins at step 202. In step 204, MS 106 transmits a registration request to wireless tower 108. This registration request includes the MIN of MS 106, which is 4046587439 in this example. This registration request is relayed by wireless tower 108 to MSC 102 in step 206. In step 208, MSC 102 determines the identity of the serving HLR in database 124 with the transmitted MIN. MSC 102 then transmits the registration request to HLR 118 over SS7 signaling links 104 in step 210. In step 212, HLR 118 accesses MSS database 128 based upon the transmitted MIN. HLR 118 determines the MDN that corresponds to the MIN for SDCA 110 in database 128, which is (602) 902-0645. HLR 118 transmits MDN (602) 902-0645 in a registration response to MSC 102 over SS7 signaling link 104. The registration response is sent in step 214. In step 216, MSC 102 relays the registration response via wireless tower 108 to MS 106. The registration is then complete and ends in step 218.

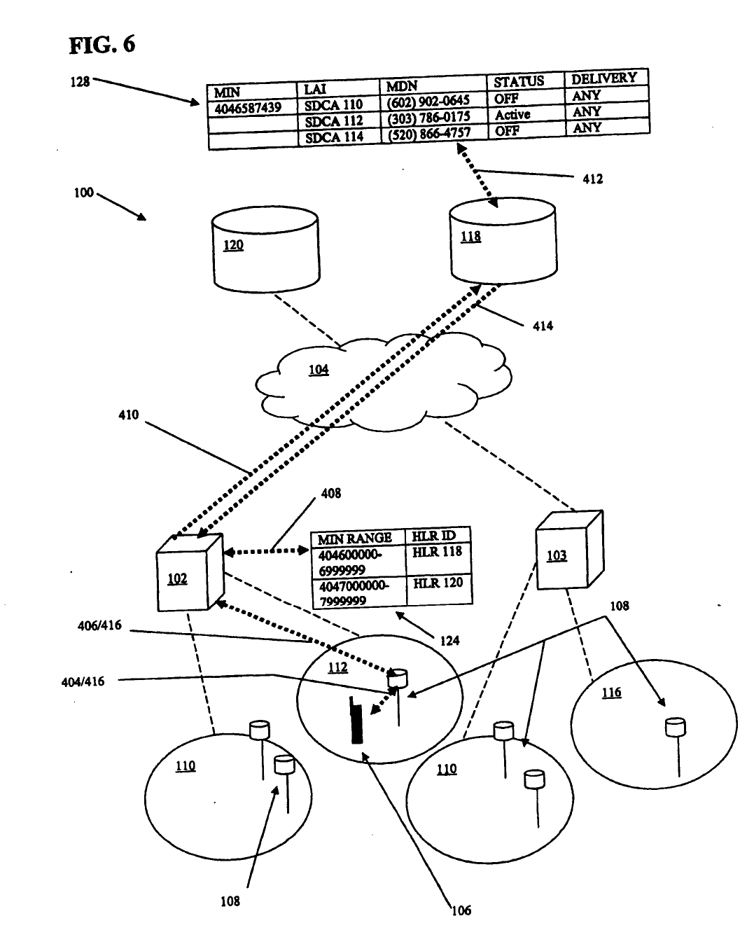

FIG. 6 illustrates a wireless network supporting a Multiple Subscription Service and a registration of MS 106 in a subscribed Short Distance Charging Area 112. When MS 106 is turned on in SDCA 112, it transmits a registration request message 404 to wireless tower 108. Wireless tower 108 transmits this registration request to MSC 102 in a communication 406. MSC 102 makes a query 408 of database to locate the home HLR of MS 106 based upon the MIN received from MS 106, which in this case is HLR 118. MSC 102 sends a registration request message 410 to the HLR 118 along with an LAI identifying SDCA 112. HLR 118 receives the MIN and LAI information and makes a query 412 of MSS Database 128 to determine the corresponding MDN that MS 106 will operate under in SDCA 112. HLR 118 then registers MS 106 as active with the MDN corresponding to SDCA 112, which is (303) 786-0175, based upon the received message containing the MIN and LAI information. This MDN is passed back to MSC 102 in a response message 414 to the registration request from MS 106. HLR 118 then updates its MSS Database to note the identity and of MSC 102 that is serving MS 106 against the MIN of MS 106 and status. MSC 102 relays the registration response to MS 106 via wireless tower 108 in communication 416.

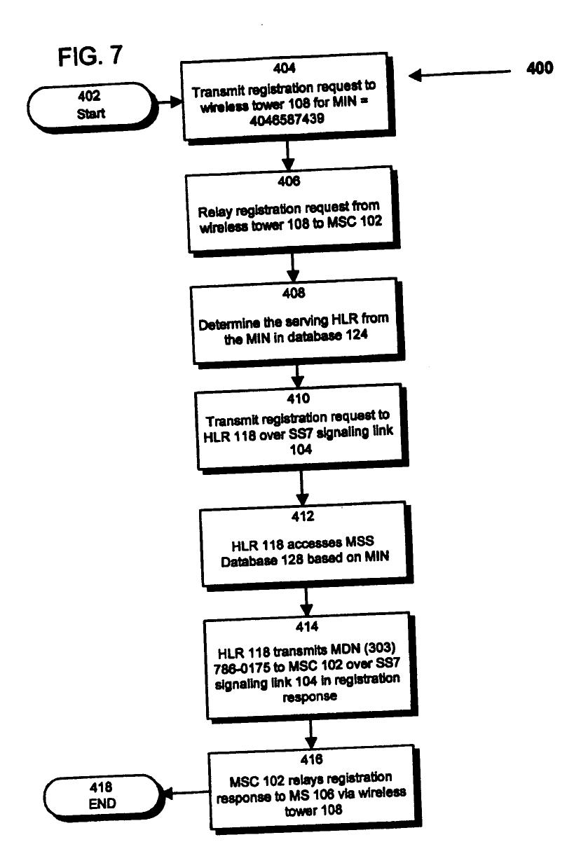

FIG. 7 depicts a flowchart 400 that illustrates registration of MS 106 with an MSS system in subscribed Short Distance Charging Area 112. FIG. 7 illustrates the process occurring in FIG. 6. Registration begins at step 402. In step 404, MS 106 transmits a registration request to wireless tower 108. This registration request includes the MIN of MS 106, which is 4046587439 in this example. This registration request is relayed by wireless tower 108 to MSC 102 in step 406. In step 408, MSC 102 determines the serving HLR in database 124 based upon the MIN transmitted in the registration request. MSC 102 transmits the registration request to HLR 118 over SS7 signaling links 104 in step 410. In step 412, HLR 118 accesses MSS database 128 based upon the transmitted MIN. HLR 118 determines the MDN that corresponds to the MIN for SDCA 112 in database 128, which is (303) 786-0175. HLR 118 then transmits MDN (303) 786-0175 in a registration response to MSC 102 over SS7 signaling link 104. The registration response is sent in step 414. In step 416, MSC 102 relays the registration response via wireless tower 108 to MS 106. The registration is then complete and ends in step 418.

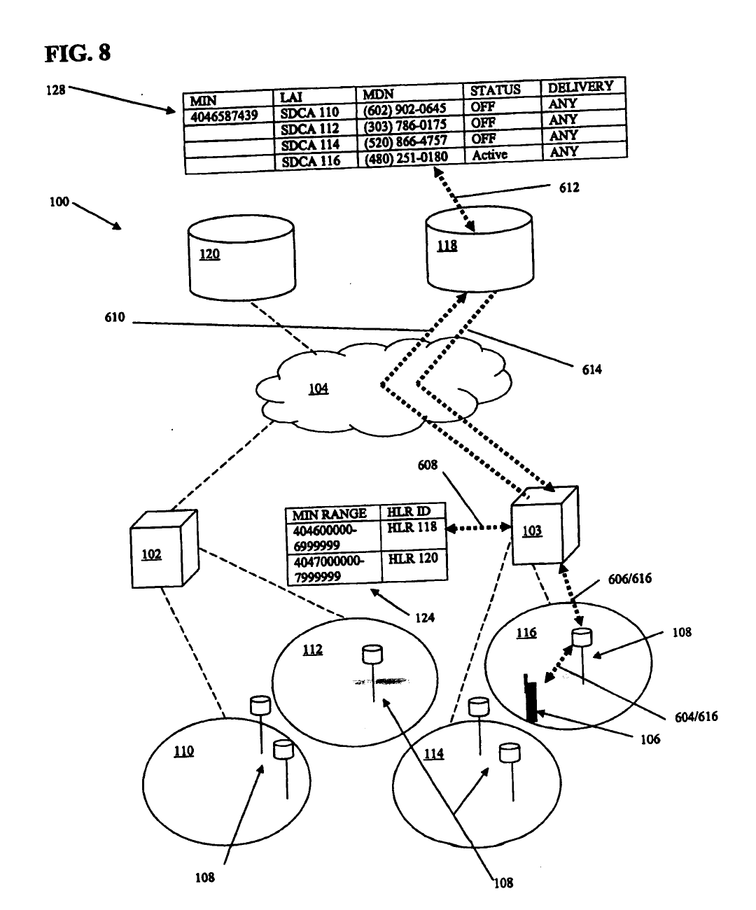

FIG. 8 illustrates a wireless network supporting a Multiple Subscription Service and a registration of MS 106 in an unsubscribed Short Distance Charging Area. MS 106 is not subscribed in SDCA 116. When MS 106 is turned on in SDCA 116, it transmits a registration request message 604 to wireless tower 108. Wireless tower 108 relays the registration request in communication 606 to serving MSC 103. MSC 103 makes a query 608 database 124 to locate the home HLR of MS 106 based upon the received MIN, which in this case is HLR 118. MSC 103 sends a registration request message 610 to the HLR 118 along with an LAI identifying SDCA 116. HLR 118 receives the MIN and LAI information and makes a query 612 of MSS Database 128 to determine the corresponding MDN that MS 106 will operate under in SDCA 116. In this case, HLR discovers that MS 106 does not have a subscription for operation in SDCA 116 in record 128. As a result, HLR 118 then activates an MSS “self-subscription” process.

In the MSS self-subscription process, HLR 118 sends a subscription request through SS7 network 104 in order to acquire an available MDN for SDCA 116. In this case, the available MDN number for SDCA 116 is (480) 251-0180. MSS writes this MDN in the MSS Database and affiliates it with the MIN of MS 106. HLR 118 then registers MS 106 as active with the MDN corresponding to SDCA 116, which is (480) 251-0180. This MDN is passed back to MSC 128 in the response message 614 to the registration request from MS 106. HLR 118 then updates its MSS Database to note the identity of MSC 103 that is serving MS 106 against the MIN of MS 106 and the status. MSC 103 relays the registration response to MSC 106 via tower 108 in message 616.

Under MSS, MS 106 has a different MDN for each SDCA. As a result, as MS 106 roams amongst SDCAs 110, 112, 114, and 116, MS 106 will change to the corresponding MDN affiliated with the respective SDCA it is operating in. By use of the MSS Database, MS 106 remains active as it roams amongst SDCAs 110, 112, 114, and 116. Consequently, in spite of the fact that the individual subscriptions that MS 106 operates under allows for operation only in one SDCA, MSS enables 106 to operate in and roam between multiple SDCAs by integrating multiple subscriptions seamlessly into a MSS Database.

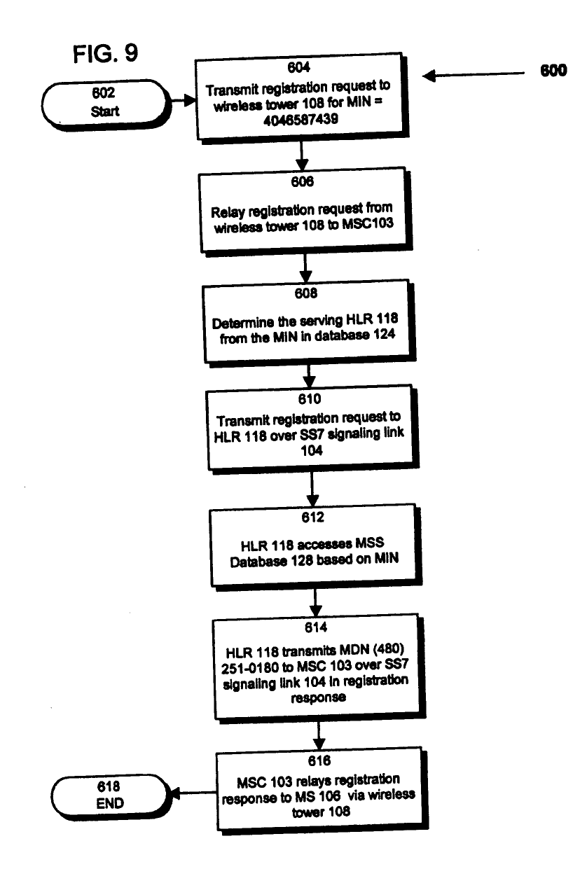

FIG. 9 depicts a flowchart 600 that illustrates registration of MS 106 with an MSS system in an unsubscribed Short Distance Charging Area 116. FIG. 9 illustrates the process occurring in FIG. 8. Registration begins at step 602. In step 604, MS 106 transmits a registration request to wireless tower 108. This registration request includes the MIN of MS 106, which is 4046587439 in this example. This registration request is relayed by wireless tower 108 to MSC 103 in step 606. In step 608, MSC 103 determines the serving HLR in database 124 based upon the transmitted MIN. MSC 103 transmits the registration request to HLR 118 over SS7 signaling links 104 in step 610. In step 612, HLR 118 accesses MSS database 128 based upon the transmitted MIN. HLR 118 determines the MDN that corresponds to the MIN for SDCA 116 in database 128, which is (480) 251-0180. HLR 118 then transmits MDN (480) 251-0180 in a registration response to MSC 103 over SS7 signaling link 104. The registration response is sent in step 614. In step 616, MSC 103 relays the registration response via wireless tower 108 to MS 106. The registration is then complete and ends in step 618.

FIG. 10 illustrates an origination of a wireless communication MS 106 operating with Multiple Subscription Service. Once registered with wireless network 100, MS 106 is able to originate telephone calls. In order to make a telephone call, MS 106 will transmit a message 804 to wireless tower 108 containing the Digit ANA, which is the dialed number. Wireless tower 108 relays message 804 to MSC 102 in a communication 806. MSC 102 makes a query 808 of database 124 to determine how to direct the call based upon the Digit ANA. MSC 102 then places an outbound call 810 to the dialed number. Since serving MSC 102 already has the active MDN corresponding to the MIN for MS 106, MSC 102 sends the outbound call message 810 with the MDN of MS 106 as the Calling Line Identity (CLI). MSC 102 also generates a Call Data Record (CDR) for all originating calls where the MIN/MDN of the caller is captured. A billing system integrated with MSS uses this data along with the number of the called party, air-time, and other information to determine the cost of the telephone call. This process of originating a phone call from MS 106 is identical regardless of whether MS 106 is operating in SDCA 110, 112, 114, or 116. For mobile originated calls initiated by MS 106, the Calling Line Identity (CLI) of MS 106 is the MDN of MS 106 that corresponds to the active MDN.

Once registered with wireless network 100, MS 106 is able to receive Mobile Terminated (MT) telephone calls. Due to the fact that MS 106 can operate in different SDCAs under different MDNs, there are a variety of ways to configure the delivery of mobile terminated telephone calls. It is possible to grant both the network provider as well as the end subscriber with discretion as to how to configure the delivery of mobile terminated telephone calls.

The MSS Database includes a pointer that identifies the active MDN of MS 106, shown in table 128 as status. It is possible to configure the delivery of mobile terminated telephone calls with MSS so that calls are only delivered to MS 106 if the caller has dialed the active MDN. Alternatively with MSS, it is possible to limit delivery to mobile terminated telephone calls to only those where the caller has dialed the MDN affiliated with the home SDCA 110. In addition with MSS, it is possible to deliver those mobile terminated telephone calls made to the MDN of the home SDCA or the active MDN to MS 106. Further, it is possible with MSS to deliver mobile terminated telephone calls that are dialed to any MDN affiliated with MS 106. In the case where calls are not delivered to MS 106, they are delivered to the local Voice Mail System (VMS) of the MDN called.

FIG. 11 depicts a flowchart 800 that illustrates an origination of a wireless communication from MS 106 operating with Multiple Subscription Service. FIG. 11 illustrates the process occurring in FIG. 12. The origination of a telephone call begins at step 802. In step 804, MS 106 transmits an outbound call to ABCXXXX to wireless tower 108. Wireless tower 108 relays the outbound call to MSC 102 in step 806. In step 808, MSC 102 determines the TG NO. from the digit ANA in database 124. MSC 102 then relays the outbound call in communication 810 to ABCXXXX with CLI=(602) 902-0645, which is the MDN that corresponds to SDCA 110. The origination process then ends in step 812.

FIG. 12 illustrates an exemplary termination of a wireless communication to a wireless phone registered with a home Short Distance Charging Area. In FIG. 10, MS 106 has already registered with wireless network 100. A third party dials the home MDN of MS 106 in communication 1004, which is (602) 902-0645. The call is directed to an MSC that corresponds to the MDN dialed, which in this case is MSC 102. MSC 102 accesses its database 124 in a query 1006 to locate the serving HLR of the dialed subscriber based upon the MDN received. MSC 102 then sends a location request message 1008 to the serving HLR, which in this case is HLR 118. In this example, the HLR that serves MSC 102 is also the home HLR that supports MS 106. This location request message 1008 includes the dialed MDN and the LAI of MSC 102. HLR 118 accesses the MSS database in a query 1010 to determine the location of MS 106 to which the call is dialed. In the MSS Database, HLR 118 maps the dialed MDN to the affiliated MIN and determines the LAI of MS 106 in record 128. In this example, the LAI of MS 106 is SDCA 110. Due to the fact that the MSC sending the location request message 1008 is also the serving MSC for MS 106, HLR 118 determines that this is a case of “Intra-MSC” call completion. Since the third party called the MDN of the home SDCA, which is also the active SDCA, under MSS the call is delivered to MS 106 under the different delivery options available as described above. HLR 118 sends a message 1012 in response to the location request from MSC 102 including the MIN of MS 106 as well as an indication that this is a local intra-MSC call. MSC 102 then pages the subscriber in SDCA 110 in a communication 1014 and completes the telephone call to MS 106 by paging MS 106 with the MIN.

During this telephone call, MSC 102 will capture the number dialed by the third party, the MIN of the called party, and the MDN of the calling party. MSC 102 will then generate a CDR with respect to the dialed number and the MIN of the called party, which in this case is the MSS subscriber. Then, MSS in concert with SS7 Network 104 generates a bill for the MSS subscriber of MS 106.

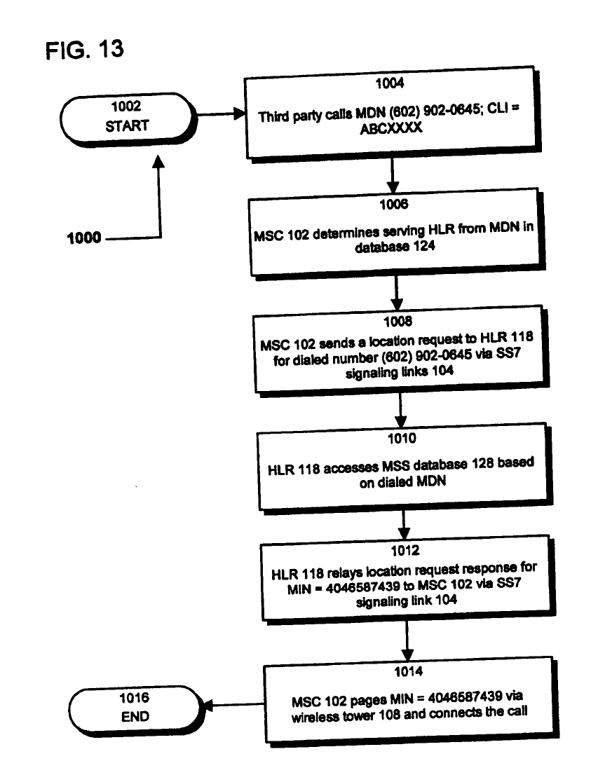

FIG. 13 depicts a flowchart 1000 that illustrates an exemplary termination of a wireless communication to MS 106 registered with home Short Distance Charging Area 110. FIG. 13 illustrates the process occurring in FIG. 12. The call termination process begins at step 1002. In step 1004, a third party calls MDN (602) 902-0645 with CLI ABCXXXX. MSC 102 receives this third party call. MSC 102 then determines the serving HLR from the dialed MDN in database 124 in step 1006. Then in step 1008, MSC 102 sends a location request to HLR 118 for dialed number (602) 902-0645 via SS7 signaling links 104. HLR 118 accesses MSS database 128 based on the dialed MDN to determine the MIN affiliated with the dialed MDN in step 1010. In step 1012, HLR 118 relays a location request response message for MIN=4046587439 to MSC 102 via SS7 signaling link 104. MSC 102 then pages MS 106 MIN=4046587439 via wireless tower 108 and completes the call in step 1014. The process then ends in step 1016.

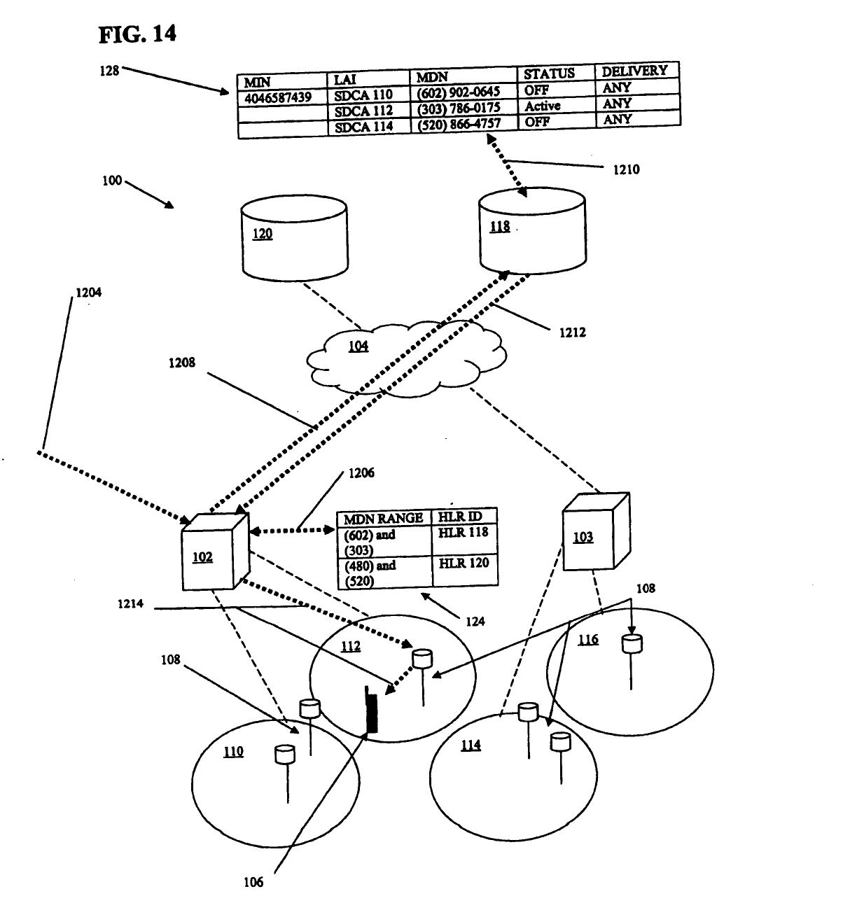

FIG. 14 illustrates an exemplary termination of a wireless communication to a wireless phone registered with in a subscribed Short Distance Charging Area. A third party caller dials the MDN of SDCA 112 in a communication 1204. MS 106 is located in SDCA 112. This telephone call is directed to the MSC that supports SDCA 112, which is MSC 102, due to the dialed MDN. MSC 102 accesses its database 124 with a query 1206 to locate the serving HLR of the dialed subscriber based upon the MDN received. MSC 102 then sends a location request message 1208 to the serving HLR, which in this case is HLR 118. This location request message 1208 includes the dialed MDN and the LAI of MSC 102. HLR 118 accesses the MSS database with a query 1210 to determine the location of MS 106 to which the call is dialed. In the MSS Database, HLR 118 maps the dialed MDN to the affiliated MIN and determines the LAI of MS 106 with table 128. In this example, the LAI of MS 106 is SDCA 112. Further, because MS 106 is active in SDCA 112, the MSS Database includes a pointer designating that the MDN corresponding to SDCA 112 is the active MDN in the status column of table 128.

Depending upon the settings of the call delivery preferences, the call may or may not be delivered to MS 106. If the subscriber of MS 106 elected to only receive calls dialed to the MDN corresponding to the home SDCA, MSS would not connect the call to MS 106. If the subscriber elected to receive calls directed to the active MDN, HLR 118 would determine that the call should get connected to MS 106. Since, in this example, the MSC sending the location request message is also the serving MSC for MS 106, HLR 118 determines that this is a case of “Intra-MSC” call completion. Since the third party called the MDN of the home SDCA, which is also the active SDCA, under MSS the call is delivered to MS 106 under the different delivery options available as described above. HLR 118 sends a message 1212 in response to the location request from MSC 102 including the MIN of MS 106 as well as an indication that this is a local intra-MSC call. MSC 102 then pages the subscriber in SDCA 112 and completes the telephone call in a communication 1214.

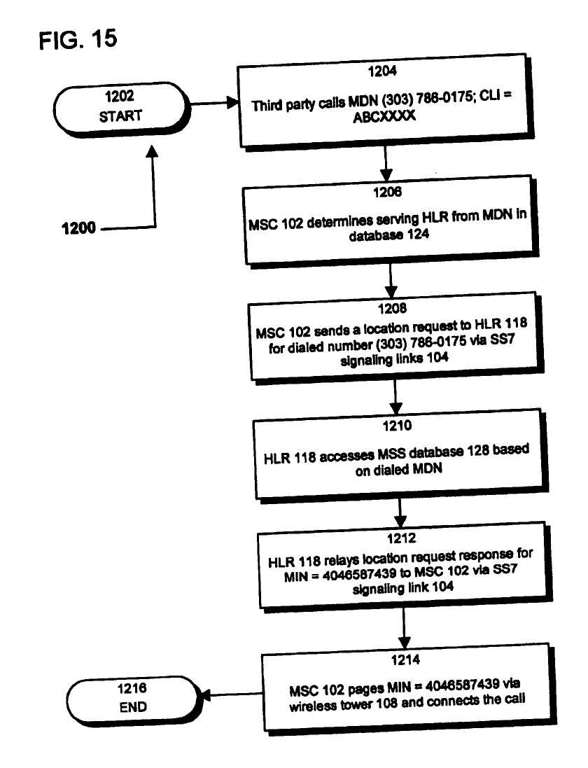

FIG. 15 depicts a flowchart 1200 that illustrates an exemplary termination of a wireless communication to MS 106 registered with in subscribed Short Distance Charging Area 112. FIG. 15 illustrates the process occurring in FIG. 14. The call termination process begins at step 1202. In step 1204, a third party calls MDN (303) 786-0175 with CLI ABCXXXX. MSC 102 receives this third party call. MSC 102 then determines the serving HLR from the dialed MDN in database 124 in step 1206. Then in step 1208, MSC 102 sends a location request to HLR 118 for dialed number (303) 786-0175 via SS7 signaling links 104. HLR 118 accesses MSS database 128 based on the dialed MDN to determine the MIN affiliated with the dialed MDN in step 1210. In step 1212, HLR 118 relays a location request response message for MIN=4046587439 to MSC 102 via SS7 signaling link 104. MSC 102 then pages MS 106 MIN=4046587439 via wireless tower 108 and completes the call in step 1214. The process then ends in step 1216.

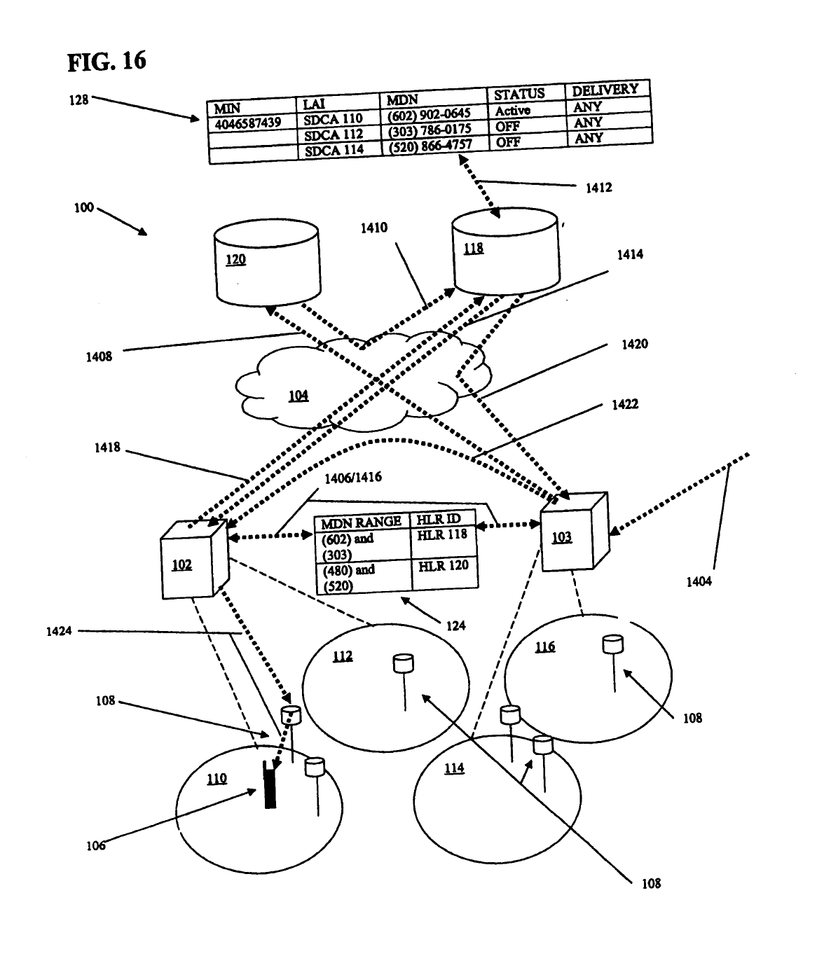

FIG. 16 illustrates an exemplary termination of a wireless communication to a wireless phone registered where the wireless phone is operating in an area that is different than the one covered by the dialed Mobile Designation Number. A third party caller dials the MDN of SDCA 114 in a communication 1404, which is (520) 866-4757. Note however, that MS 106 is located and registered in SDCA 110. This telephone call is directed to the MSC that supports SDCA 114, which is MSC 103, due to the dialed MDN. MSC 103 accesses its database 124 with a query 1406 to locate the serving HLR of the dialed subscriber based upon the MDN received. In this case, MSC 103 will determine that the HLR is HLR 120, not the actual home HLR 118, due to the dialed MDN that corresponds to SDCA 114.

MSC 103 then sends a location request message 1408 to serving HLR 120. This location request message includes the dialed MDN and the LAI of MSC 103. HLR 120 accesses the MSS database to determine the location of MS 106 to which the call is dialed. From accessing the MSS database, HLR 120 locates the MIN of MS 106 and determines that it is not the home HLR from table 128. Since it is not the home HLR 118, HLR 120 could not provide the location of MS 106. Consequently, HLR 120 locates the home HLR, HLR 118, based upon the MIN associated with the dialed MDN in the MSS Database. HLR 120 then relays the location request message to HLR 118 in communication 1410. HLR 118 accesses its MSS Database 128 with query 1412 to determine the current location and status of MS 106. HLR 118 then locates the record 128 for MS 106 in the MSS Database from the MIN. In this MSS Database record 128, HLR 118 finds that MS 106 is active under the MDN for SDCA 110.

After ascertaining whether MS 106 is active and where it is located, HLR 118 determines whether it should deliver the call to MS 106. HLR 118 locates the delivery preferences set for MS 106 in the MSS Database record 128. If the delivery preferences are set where MS 106 only accepts calls dialed to the home MDN or active MDN, then the called placed to the MDN for SDCA 114 will not get delivered. However, if the delivery preferences are set where MS 106 will accept a call placed to “ANY” of the MDN that it is affiliated with, then HLR 118 will proceed with delivering the phone call.

To proceed with delivering the call to MS 106, HLR 118 passes the MIN of MS 106 in a message 1414 to MSC 102 that serves SDCA 110 where MS 106 is located. When passing the MIN to MSC 102, HLR 118 requests in message 1414 that MSC 102 provide a Temporary Local Directory Number (TLDN) for completing the call. MSC makes a query 1416 of database 124 to determine the TLDN. Upon receiving the TLDN from HLR 118 in message 1418, HLR 118 passes the TLDN to MSC 103 in communication 1420 along with the MIN of MS 106. MSC 103 then forwards the call to MSC 102 in communication 1422. MSC 102 transmits the call through wireless tower 108 to MS 106 in communications 1424.

MSC 103 generates a call delivery CDR for the portion of the call between MSC 103 and MSC 102. This CDR would contain the MIN of the terminating party, the TLDN of serving MSC 102, the MDN of the third party caller, and the MDN called by the third party caller, which is the MDN of MSC for SDCA 114. This CDR would also contain an originating network billing identification.

For this same call, MSC 102 also generates a terminating call CDR. This CDR includes information such as the MIN of MS 106, the active MDN of MS 106, and the MDN of the third party caller. In addition, this CDR contains the TLDN used for the call, as well as the terminating network billing identification. The network billing identification generated in the CDR of MSC 103 and MSC 102 are common to each other, thereby enabling wireless network 100 to generate a single bill for the entire call.

Under one subscription, MS 106 is only able to operate in a single SDCA. However, by use of MSS, MS 106 is able to seamlessly function in multiple SDCAs within wireless network 100. In addition to handling the calling traffic for MS 106 in multiple SDCAs, MSS also supports a billing infrastructure. Based upon the various CDRs generated during the origination and termination of telephone calls for MS 106, MSS generates a bill that is sent to the customer of MS 106 in his home SDCA 110, or as otherwise directed by the customer. MSS integrates all of the telephone charges for each MDN affiliated with MS 106 into a single bill for the subscriber. As a result, despite having multiple MDNs for MS 106, MSS is able to provide the subscriber with a single bill.

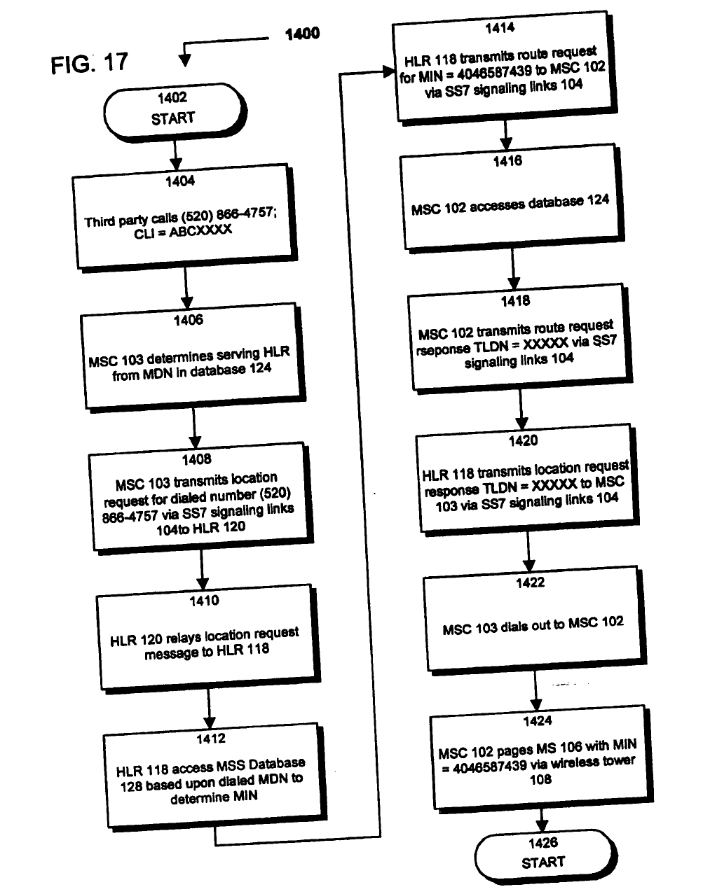

FIG. 17 depicts a flowchart that illustrates an exemplary termination of a wireless communication to MS 106 registered where MS 106 is operating in an area that is different than the one covered by the dialed Mobile Designation Number. FIG. 17 illustrates the process occurring in FIG. 16. The call termination process begins in step 1402. In step 1404, a third party calls MDN (520) 866-4757 with CLI ABCXXXX. MSC 103 receives this third party call. MSC 103 then determines the serving HLR from the dialed MDN in database 124 in step 1406. Then in step 1408, MSC 103 sends a location request to HLR 120 for dialed number (520) 866-4757 via SS7 signaling links 104. In step 1410, HLR 120 relays the location request message to HLR 118 due to the fact that HLR 118 supports the MIN associated with the dialed MDN (520) 866-4757. HLR 118 accesses MSS database 128 based on the dialed MDN to determine the MIN affiliated with the dialed MDN in step 1412. In step 1414, HLR 118 transmits a route request for MIN=4046587439 to MSC 102 via SS7 signaling links 104. MSC 102 accesses database 124 for location information on MS 106 in step 1416. MSC 102 transmits a route request response TLDN=XXXXX via SS7 signaling links 104 in step 1418. In step 1420, HLR 118 transmits location request response TLDN=XXXXX to MSC 103 via SS7 signaling links 104. Then in step 1422, MSC 103 dials out to MSC 102 to establish a voice trunk. MSC 102 then pages MS 106 with MIN=4046587439 via wireless tower 108 and completes the call. The process then ends in step 1426.

A variant of the MSS service is the Temporary Subscription Service (TSS). When MS 106 is subscribed in a particular SDCA with MSS, the affiliated MDN for each SDCA is indefinitely reserved for MS 106. However, with TSS, MS 106 may acquire temporary subscriptions to MDNs in other SDCAs, thereby increasing the number of available MDNs and increasing customer options.

MSS also supports a Short Messaging Service (SMS). SMS is the transmission of short text messages to and from a mobile phone, a pager, or other wireless device. These short messages are typically no longer than 160 alpha-numeric characters and contain no images or graphics. This limited amount of data allows for low memory and display capable devices to view text intelligently. Once a message is sent, it is received by a Short Message Service Center (SMSC), which then distributes the message to the appropriate mobile device. To do this, the SMSC sends a SMS Request to the HLR to find the roaming customer. Once the HLR receives the request, it will respond to the SMSC with the subscriber's status. If the response is “inactive”, then the SMSC will hold onto the message for a period of time. When the subscriber accesses his device, the HLR sends a SMS notification to the SMSC, and the SMSC will attempt delivery. The SMSC transfers the message in a Short Message Delivery Point to Point (SMDPP) format to the serving system. The system pages the device, and if it responds, the message gets delivered. The SMSC receives verification that the message was received by the end user and then categorizes the message as “sent” and will not attempt to send again.

FIG. 18 illustrates a transmission of a mobile originated text message to a phone operating with a Multiple Subscription Service. An SMSC 130 is in communication with wireless network 100. A wireless device 132 submits an SMDPP message 1604 to (520) 866-4757. Message 1604 is received by MSC 103 where it is forwarded to SMSC 130 in communication 1606. SMSC 130 accesses database 134 with query 1608 where it determines the correct HLR for directing the text message. From this table, SMSC 130 determines that HLR 120 is the correct HLR based upon the dialed MDN from the SMDPP. SMSC 130 transmits the SMS request to HLR 120 in communication 1610. HLR 120 receives the SMS request from SMSC 130 and accesses MSS database 128 with query 1612 to determine the MIN associated with the MDN dialed in the SMDPP. HLR 120 determines that the MIN is 4046587439 and that the correct HLR is HLR 118. HLR 120 then relays the SMS request to HLR 118 in communication 1614. HLR 118 then accesses MSS Database 128 with query 1616 to determine the location and status of MS 106 from the MIN. HLR 118 sends an SMS request response 1618 to SMSC 130 that includes the MIN and LAI of MS 106. SMSC 130 then delivers the SMDPP to serving MSC 102 in communication 1620. MSC 102 then delivers the SMDPP to MS 106 with communication 1622 via wireless tower 108.

FIG. 19 depicts a flowchart that illustrates a transmission of a mobile originated text message to a phone operating with a Multiple Subscription Service. FIG. 19 illustrates the process occurring in FIG. 18. The transmission process begins in step 1602. In step 1604, MS 132 submits an SMDPP to the MDN (520) 866-4757 to MSC 103. MSC 103 then relays the SMDPP to SMC 130 in step 1606. In step 1608, SMC 130 determines the serving HLR based on the dialed MDN in database 134. SMC transmits an SMS request for MDN=(520) 866-4757 to HLR 120 via SS7 signaling links 104 in step 1610. In step 1612, HLR 120 access MSS database 128 to determine the MIN affiliated with the dialed MDN. HLR 120 determines the HLR 118 is the serving HLR based upon the affiliated MIN. HLR 120 relays the SMS request to HLR 118 due to the fact that HLR 118 supports the affiliated MIN in step 118. In step 1616, HLR 118 accesses the MSS database 128 to determine the MIN based upon the dialed MDN. HLR 118 sends an SMS request response with MIN=4046587439 to SMC 130 via SS7 signaling links 104 in step 1618. In step 1620, SMC 130 transmits SMDPP delivery for MIN=4046587439 to MSC 102. MSC 102 then completes SMDPP delivery for MIN 4046587439 to MS 106 via wireless tower 108. The process then ends in step 1624.

It is noted that the foregoing examples have been provided merely for the purpose of explanation and are in no way to be construed as limiting of the present invention. While the present invention has been described with reference to certain embodiments, it is understood that the words which have been used herein are words of description and illustration, rather than words of limitation. Changes may be made, within the purview of the disclosure, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses.

1. A wireless communications system, comprising:
a digital network divided into a plurality of regions;
a wireless device;
a subscription that provides connectivity for said wireless device to said digital network for one of said regions without an ability to operate outside of said region;
a multiple subscription system that enables said wireless device to operate under more than one of said subscriptions concurrently, thereby providing said wireless device with connectivity to said digital network in more than one of said regions.
